(19) United States
(12) Patent Application Publication
(10) Pub. No.: US 2009/0140022 A1
(43) Pub. Date: Jun. 4, 2009

(54) Bicycle power unit case

(75) Inventor: Chun-Hung Lin, Taichung City (TW)

Correspondence Address: LIN, CHUN-HUNG, P.O.Box 44-2049, Taipei, 10668, TW

(73) Assignee: IDEAL BIKE CORP.

(21) Appl. No.: 11/987,590

(22) Filed: Dec. 3, 2007

(51) Int. Cl. B62J 11/00

(52) U.S. Cl. 224/425

(57) ABSTRACT

A bicycle power unit case includes a controller received therein and a power unit is inserted into the case from a top of the case and electrically connected to the controller. The case includes a bottom-bracket hole through which the bottom bracket and crank extend. The case is connected to a low and central portion of the bicycle. The down tube, the seat tube and the chain stays are respectively inserted and fixed to the case. The power unit case does not affect the center of weight of the bicycle and the power unit can be easily replaced from a top of the case.

### BACKGROUND OF THE INVENTION

(1) Field of the Invention

The present invention relates to a bicycle power unit case which is combined with bottom bracket hole and is located at lower and central position of the bicycle.

(2) Description of the Prior Art

A conventional bicycle with a power unit generally includes a power unit case which is connected to the top or bottom of the back rack. This position is easily to be accessed so that the user can convenient to replace a new battery for the power unit. However, the position makes the center of the weight to move backward especially when the bicycle is ridden on steep roads. Some power unit is fixed in an area enclosed by seat tube, down tube and top tube. This position improves the shortcoming of the above mentioned problem, but the power unit is inconvenient to be accessed and replaced.

The present invention intends to provide a bicycle power unit case which is mounted to the position wherein the bottom bracket is located and the bottom bracket extends through the case.

### SUMMARY OF THE INVENTION

The present invention relates to a bicycle power unit case which comprises a first half and a second half which is connected to the first half so as to form a case in which a space is define. A top hole is defined through a top of the case and a power unit is inserted into the case from the top hole. A first aperture is defined in a rear end of the case and the seat tube and chain stays are inserted into the first aperture. A second aperture is defined in a front end of the case and the down tube is inserted into the second aperture.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the power unit case of the present invention;

FIG. 2 is an exploded view to show the power unit case of the present invention, the down tube, the seat tube and the chain stays;

FIG. 3 is a perspective view to show the power unit case of the present invention and the power unit case is connected with the down tube, the seat tube and the chain stays;

FIG. 4 is a perspective view to show the power unit case of the present invention;

FIG. 5 is a side view to show the power unit case is connected to a bicycle and the chain guard is engaged with a recess in a side of the power unit case, and

FIG. 6 shows the power unit case of the present invention includes a bottom cover to be engaged with the third aperture.

### DETAILED DESCRIPTION OF THE PREFERRED EMBODIMENTS

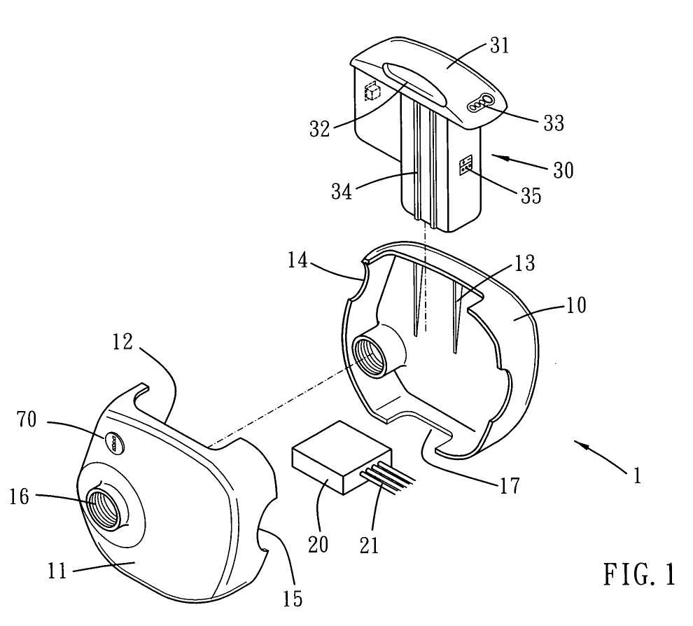

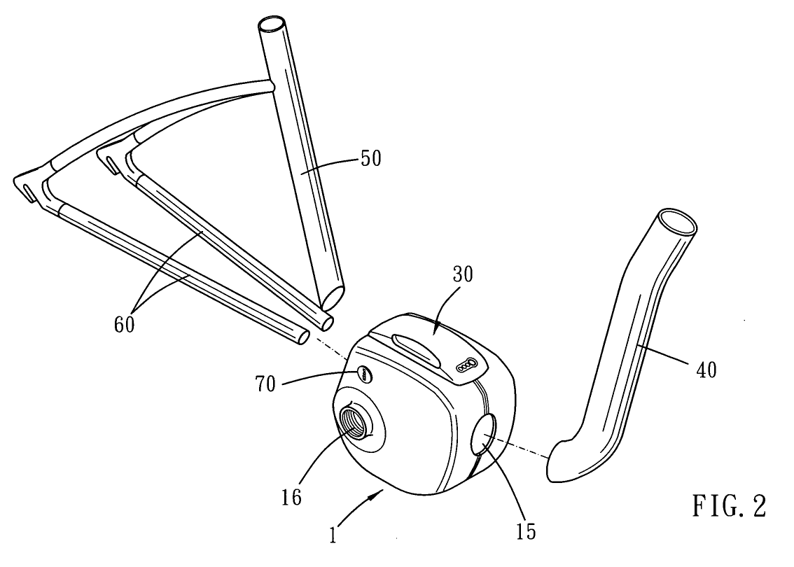

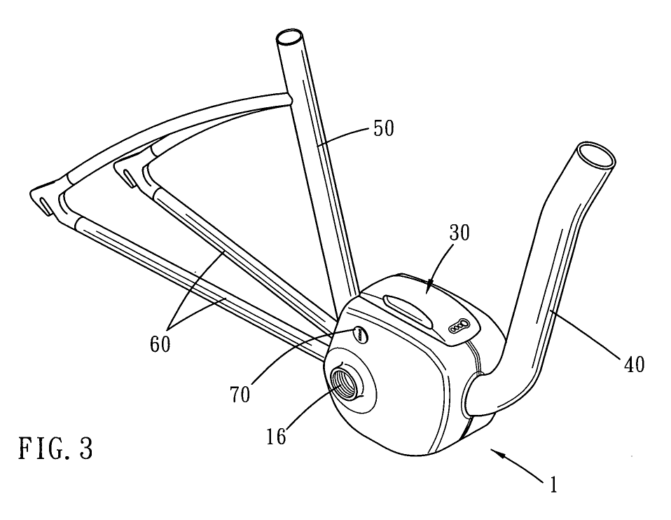

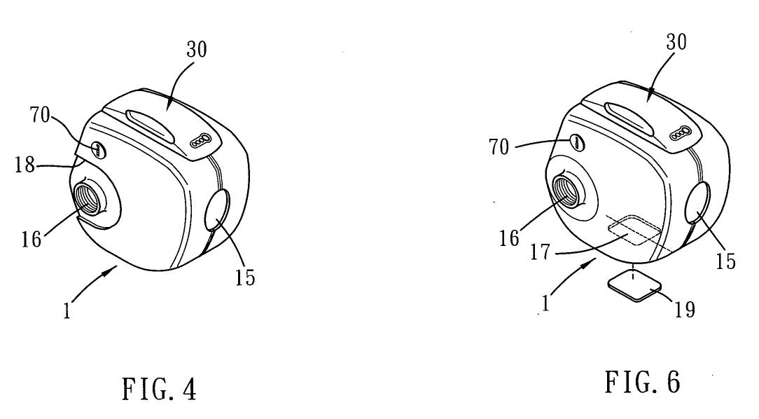

Referring to FIGS. 1 to 5, the power unit case of the present invention comprises a first half 10 and a second half 11 which is connected to the first half 10 by soldering so as to form a case 1 in which a space is define. Each of the first and second halves 10, 11 includes ribs 13 extending from an inside thereof. A top hole 12 is defined through a top of the case 1 so that a power unit 30 is inserted into the case 1 from the top hole 12. A controller 20 is received in the case 1 and electrically connected to the power unit 30 by cables 21. The power unit 30 is a battery and flanges 34 extend from an outside thereof. The flanges 34 are engaged with the ribs 13 to position the power unit 30. The power unit 30 includes a top cover 31 and a handle portion 32 is defined in the top cover 31. A display panel 33 is installed to the top cover 31 so that the user can easily check the status of the operation of the power unit 30. The cables 21 from the controller 20 are connected to the input-output terminals 35 defined in the power unit 30.

A first aperture 14 is defined in a rear end of the case 1 and the seat tube 50 and chain stays 60 are inserted into the case 1 via the first aperture 14. A second aperture 15 is defined in a front end of the case 1 and the down tube 40 is inserted into the case 1 via the second aperture 15. The down tube 40, the seat tube 50 and chain stays 60 are connected to each other at a position where the bottom bracket is located. The case 1 further includes a bottom-bracket hole 16 defined therethrough and the bottom bracket (not shown) extends through the bottom-bracket hole 16.

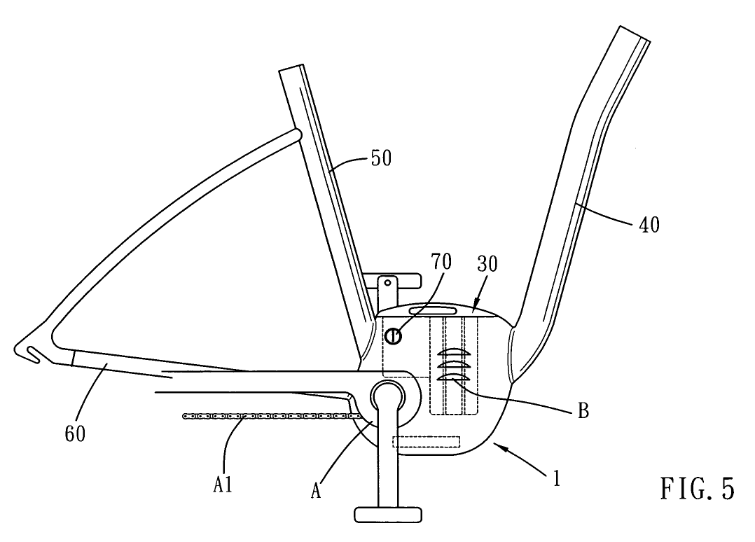

The power unit case is located at the low and center portion of the bicycle so that it does not affect balance of the bicycle. The power unit case is combined with the bottom bracket of the bicycle so that no extra securing parts or mechanism are needed. The user can easily check its status from the display panel 33 on the top cover 31. A lock 70 is connected to a side of the case 1 and locks the power unit 30 and performs as an ON/OFF switch. As shown in FIG. 5, a recess 18 is defined in a side of the case 1 and located about the bottom-bracket hole 16 so as to receive the chain guard “A” and a part of the chain “A1”. Furthermore, a plurality of ventilation holes “B” are defined through the case 1 to provide ventilation to prevent overheat to the power unit 30 and the controller 20.

As shown in FIG. 6, a third aperture 17 is defined through a bottom of the case 1 and a bottom cover 19 is engaged with the third aperture 17 with a seal ring connected between the bottom cove 19 and the periphery of the third aperture 17. The bottom cover 19 prevents water or dust from entering the case 1 and making circuit short to the controller 20. If water enters into the case 1, the water can be drained via the third aperture 17 by removing eh bottom cover 19. The bottom cover 19 can also be replaced with a net which is benefit for removing heat or moisture from the case 1.

The user can easily pull the power unit 30 out from the case 1 by holding the handle portion 32 and because there is sufficient space above the case 1 so that the replacement or maintenance to the power unit 30 will be convenient. The case 1 may further include recesses for receiving the chain wheel or even the bicycle parking tube.

While we have shown and described the embodiment in accordance with the present invention, it should be clear to those skilled in the art that further embodiments may be made without departing from the scope of the present invention.

What is claimed is:

1. A bicycle power unit case comprising:
a first half and a second half which is connected to the first half so as to form a case in which a space is define, a top hole defined through a top of the case, a first aperture defined in a rear end of the case and being adapted to receive a down tube, a second aperture defined in a front end of the case and being adapted to receive a seat tube and chain stays, and
a power unit inserted into the case from the top hole.

2. The case as claimed in claim 1, wherein the power unit is a battery.

3. The case as claimed in claim 1, wherein the power unit includes a top cover.

4. The case as claimed in claim 3, wherein the top cover includes a handle portion.

5. The case as claimed in claim 3, wherein the top cover includes a display panel.

6. The case as claimed in claim 1, wherein each of the first and second halves includes ribs extending from an inside thereof and the power unit includes flanges extending from an outside thereof, the flanges are engaged with the ribs to position the power unit.

7. The case as claimed in claim 1, wherein a controller is received in the case and electrically connected to the power unit by cables.

8. The case as claimed in claim 1, wherein the case includes a bottom-bracket hole defined therethrough.

9. The case as claimed in claim 1, wherein a third aperture is defined through a bottom of the case.

10. The case as claimed in claim 9, wherein a bottom cover is engaged with the third aperture.

11. The case as claimed in claim 1, wherein a lock is connected to a side of the case.

12. The case as claimed in claim 1, wherein a recess is defined in a side of the case and adapted to receive a chain guard.
